(19) United States
(12) Patent Application Publication
(10) Pub. No.: US 2026/0360068 A1
(43) Pub. Date: Nov. 12, 2026

(54) IMPROVED PARALLEL REFIT OPERATIONS

(71) Applicant: Advanced Micro Devices, Inc., Santa Clara, CA (US)

(72) Inventor: Rohan Mehalwal, Orlando, FL (US)

(73) Assignee: Advanced Micro Devices, Inc., Santa Clara, CA (US)

(21) Appl. No.: 19/200,424

(22) Filed: May 6, 2025

(51) Int. Cl. G06T 15/00

(52) U.S. Cl. CPC G06T 15/00

(57) ABSTRACT

This disclosure provides techniques for improving performance of a refit operation. In particular, the techniques involve identifying portions of the BVH that can be processed together for improved utilization of memory resources. These identified portions are subtrees of the BVH, where each subtree is a hierarchically related set of nodes of the BVH. Performing a refit operation occurs in a bottom-up manner, so that the results (e.g., updated bounding volumes) from processing a large number of lower nodes are utilized in processing higher nodes. Identifying subtrees to process together allows these results to be stored in more local memories than if it such subtrees were not processed together. By processing a subtree together in a workgroup, memory local to that workgroup can be used to store updated bounding volumes for lower nodes, so that the workgroup can read those updated bounding volumes to perform a refit operation for higher nodes.

### BACKGROUND

Ray tracing is a technique has the capability to produce highly realistic images. However, this technique can be very computationally demanding. Techniques for improving ray tracing are constantly being developed.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of aspects of device, illustrating additional details related to execution of processing tasks on the APD;

FIG. 3 illustrates a ray tracing pipeline for rendering graphics using a ray tracing technique, according to an example;

FIG. 4 is an illustration of a bounding volume hierarchy, according to an example;

FIG. 5 illustrates operations for generating sub-trees from a bounding volume hierarchy (“BVH”), according to an example;

FIGS. 6A and 6B illustrate operations for performing a refit operation, using a subtree BVH, according to an example;

FIG. 7 illustrates a BVH widening operation, according to an example;

FIG. 8 is a flow diagram of a method for building a subtree BVH, according to an example; and

FIG. 9 is a flow diagram of a method for performing a refit operation, according to an example.

### DETAILED DESCRIPTION

Ray tracing is a technique capable of rendering highly realistic images by following the path of simulated light rays through a scene. While capable of generating highly realistic images, ray tracing is highly processing intensive.

A data structure referred to as a bounding volume hierarchy is used to assist with ray tracing. This data structure improves the performance of searching for objects that are intersected by a ray, but building this data structure is time consuming. To reduce the amount of time required, a refit operation is often performed, in which the tree structure of an already existing BVH is unaltered, but the bounding volumes referenced by that tree structure are updated according to changing geometry.

This disclosure provides techniques for improving performance of the refit operation. In particular, this disclosure provides techniques for identifying portions of the BVH that can be processed together for improved utilization of memory resources. These portions are subtrees of the BVH, where each subtree is a hierarchically related set of nodes of the BVH. Performing a refit operation occurs in a bottom-up manner, so that the results (e.g., updated bounding volumes) from processing a large number of lower nodes are utilized in processing higher nodes. Identifying subtrees to process together allows these results to be stored in more local memories than if it such subtrees were not processed together. For example, by processing a subtree together in a workgroup, memory local to that workgroup can be used to store updated bounding volumes for lower nodes, so that the workgroup can read those updated bounding volumes to perform a refit operation for nodes higher in the subtree.

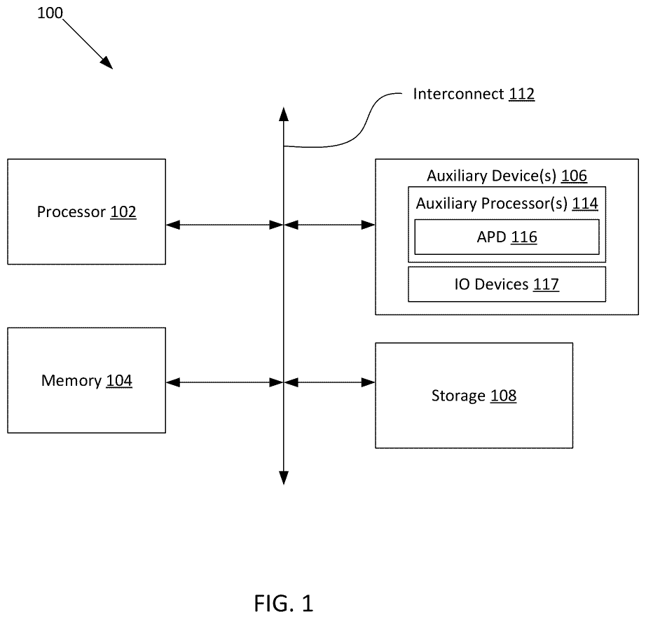

FIG. 1 is a block diagram of an example computing device 100 in which one or more features of the disclosure can be implemented. In various examples, the computing device 100 is one of, but is not limited to, for example, a computer, a gaming device, a handheld device, a set-top box, a television, a mobile phone, a tablet computer, or other computing device. The device 100 includes, without limitation, one or more processors 102, a memory 104, one or more auxiliary devices 106, and a storage 108. An interconnect 112, which can be a bus, a combination of buses, and/or any other communication component, communicatively links the one or more processors 102, the memory 104, the one or more auxiliary devices 106, and the storage 108.

In various alternatives, the one or more processors 102 include a central processing unit (CPU), a graphics processing unit (GPU), a CPU and GPU located on the same die, or one or more processor cores, wherein each processor core can be a CPU, a GPU, or a neural processor. In various alternatives, at least part of the memory 104 is located on the same die as one or more of the one or more processors 102, such as on the same chip or in an interposer arrangement, and/or at least part of the memory 104 is located separately from the one or more processors 102. The memory 104 includes a volatile or non-volatile memory, for example, random access memory (RAM), dynamic RAM, or a cache.

The storage 108 includes a fixed or removable storage, for example, without limitation, a hard disk drive, a solid state drive, an optical disk, or a flash drive. The one or more auxiliary devices 106 include, without limitation, one or more auxiliary processors 114, and/or one or more input/output (“IO”) devices. The auxiliary processors 114 include, without limitation, a processing unit capable of executing instructions, such as a central processing unit, graphics processing unit, parallel processing unit capable of performing compute shader operations in a single-instruction-multiple-data form, multimedia accelerators such as video encoding or decoding accelerators, or any other processor. Any auxiliary processor 114 is implementable as a programmable processor that executes instructions, a fixed function processor that processes data according to fixed hardware circuitry, a combination thereof, or any other type of processor.

The one or more auxiliary devices 106 includes an accelerated processing device (“APD”) 116. The APD 116 may be coupled to a display device, which, in some examples, is a physical display device or a simulated device that uses a remote display protocol to show output. The APD 116 is configured to accept compute commands and/or graphics rendering commands from processor 102, to process those compute and graphics rendering commands, and, in some implementations, to provide pixel output to a display device for display. As described in further detail below, the APD 116 includes one or more parallel processing units configured to perform computations in accordance with, for example, a single-instruction-multiple-data (“SIMD”) or a single-instruction-multiple-thread (“SIMT”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and, optionally, configured to provide graphical output to a display device. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm perform the functionality described herein.

The one or more IO devices 117 include one or more input devices, such as a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals), and/or one or more output devices such as a display device, a speaker, a printer, a haptic feedback device, one or more lights, an antenna, or a network connection (e.g., a wireless local area network card for transmission and/or reception of wireless IEEE 802 signals).

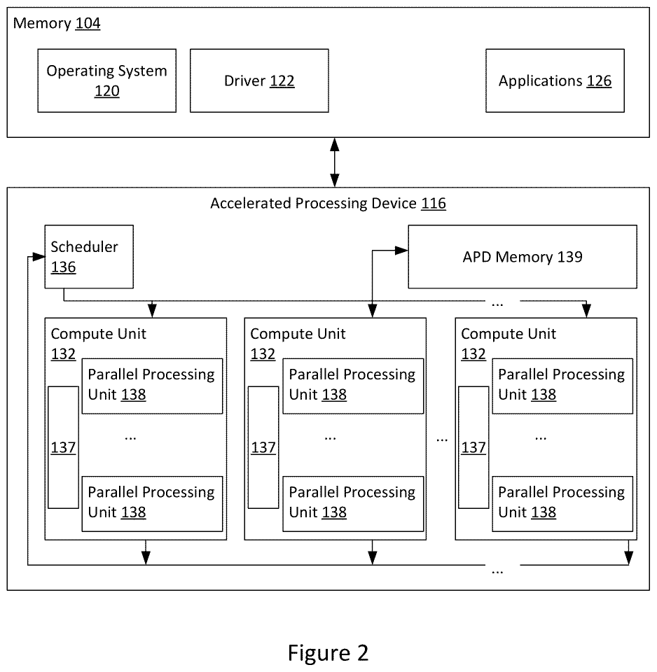

FIG. 2 is a block diagram of aspects of device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the parallel processing units 138 discussed in further detail below) of the APD 116.

The APD 116 executes commands and programs for selected functions, such as graphics operations and non-graphics operations that are or can be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more parallel processing unit 138 that perform operations at the request of the processor 102 in a parallel manner according to a parallel processing paradigm, such as SIMD or SIMT. In such paradigms, multiple processing elements execute the same instruction across multiple data elements or threads. The multiple processing elements share a single program control flow unit and program counter and thus execute the same program but are able to execute that program with or using different data. In one example, each parallel processing unit 138 includes sixteen lanes, where each lane executes the same instruction at the same time as the other lanes in the parallel processing unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program or kernel that is to be executed in parallel according to the parallel processing paradigm employed. For example, in a SIMD architecture, multiple work-items execute the same instruction simultaneously on different data elements. Work-items can be executed simultaneously as a “wavefront” on a parallel processing unit 138, where each work-item executes the same instruction with different data and where different work-items can execute a different control flow path through the use of predication. In a SIMT architecture, work-items correspond to threads that can be executed simultaneously on the parallel processing unit 138, where different threads can execute different control flow paths. Threads are grouped into “warps” or “wavefronts”, which are scheduled or executed together.

For the purposes of this description, the term “wavefront” will be used, but it should be understood that this term broadly describes work-items that can be executed simultaneously and is inclusive of both “wavefronts” and “warps.” One or more wavefronts are included in a “work group,” which includes a collection of work-items designated to execute the same program. A work group can be executed by executing each of the wavefronts that make up the work group. In alternatives, the wavefronts are executed sequentially on a single parallel processing unit 138 or partially or fully in parallel on different parallel processing unit 138. Wavefronts can be thought of as the largest collection of work-items that can be executed simultaneously on a single parallel processing unit 138. Thus, if commands received from the processor 102 indicate that a particular program is to be parallelized to such a degree that the program cannot execute on a single parallel processing unit 138 simultaneously, then that program is broken up into wavefronts which are parallelized on two or more parallel processing units 138 or serialized on the same parallel processing unit 138 (or both parallelized and serialized as needed). A scheduler 136 performs operations related to scheduling various wavefronts on different compute units 132 and parallel processing units 138.

The parallelism afforded by the compute units 132 is suitable for graphics related operations such as pixel value calculations, vertex transformations, and other graphics operations and non-graphics operations (sometimes known as “compute” operations). Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

Each compute unit 132 has a local data share, which is local memory for the compute unit 132 and inaccessible to other compute units 132. The APD 116 has an APD memory 139 that is general to the APD 116 and can be accessed by any compute unit 132.

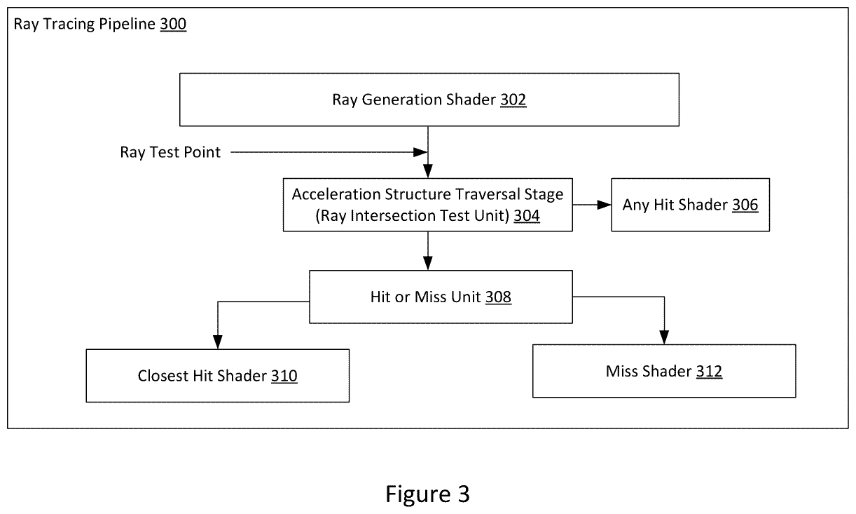

FIG. 3 illustrates a ray tracing pipeline 300 for rendering graphics using a ray tracing technique, according to an example. The ray tracing pipeline 300 provides an overview of operations and entities involved in rendering a scene utilizing ray tracing. A ray generation shader 302, any hit shader 306, closest hit shader 310, and miss shader 312 are shader-implemented stages that represent ray tracing pipeline stages whose functionality is performed by shader programs executing in the SIMD unit 138. Any of the specific shader programs at each particular shader-implemented stage are defined by application-provided code (i.e., by code provided by an application developer that is pre-compiled by an application compiler and/or compiled by the driver 122). The acceleration structure traversal stage 304 performs a ray intersection test to determine whether a ray hits a triangle.

The various programmable shader stages (ray generation shader 302, any hit shader 306, closest hit shader 310, miss shader 312) are implemented as shader programs that execute on the SIMD units 138. The acceleration structure traversal stage 304 is implemented in software (e.g., as a shader program executing on the SIMD units 138), in hardware, or as a combination of hardware and software. The hit or miss unit 308 is implemented in any technically feasible manner, such as as part of any of the other units, implemented as a hardware accelerated structure, or implemented as a shader program executing on the SIMD units 138. The ray tracing pipeline 300 may be orchestrated partially or fully in software or partially or fully in hardware, and may be orchestrated by the processor 102, the scheduler 136, by a combination thereof, or partially or fully by any other hardware and/or software unit. The term “ray tracing pipeline processor” used herein refers to a processor executing software to perform the operations of the ray tracing pipeline 300, hardware circuitry hard-wired to perform the operations of the ray tracing pipeline 300, or a combination of hardware and software that together perform the operations of the ray tracing pipeline 300.

The ray tracing pipeline 300 operates in the following manner. A ray generation shader 302 is executed. The ray generation shader 302 sets up data for a ray to test against a triangle and requests the acceleration structure traversal stage 304 test the ray for intersection with triangles.

The acceleration structure traversal stage 304 traverses an acceleration structure, which is a data structure that describes a scene volume and objects (such as triangles) within the scene, and tests the ray against triangles in the scene. In various examples, the acceleration structure is a bounding volume hierarchy. The hit or miss unit 308, which, in some implementations, is part of the acceleration structure traversal stage 304, determines whether the results of the acceleration structure traversal stage 304 (which may include raw data such as barycentric coordinates and a potential time to hit) actually indicates a hit. For triangles that are hit, the ray tracing pipeline 300 triggers execution of an any hit shader 306. Note that multiple triangles can be hit by a single ray. It is not guaranteed that the acceleration structure traversal stage will traverse the acceleration structure in the order from closest-to-ray-origin to farthest-from-ray-origin. The hit or miss unit 308 triggers execution of a closest hit shader 310 for the triangle closest to the origin of the ray that the ray hits, or, if no triangles were hit, triggers a miss shader.

Note, it is possible for the any hit shader 306 to “reject” a hit from the ray intersection test unit 304, and thus the hit or miss unit 308 triggers execution of the miss shader 312 if no hits are found or accepted by the ray intersection test unit 304. An example circumstance in which an any hit shader 306 may “reject” a hit is when at least a portion of a triangle that the ray intersection test unit 304 reports as being hit is fully transparent. Because the ray intersection test unit 304 only tests geometry, and not transparency, the any hit shader 306 that is invoked due to a hit on a triangle having at least some transparency may determine that the reported hit is actually not a hit due to “hitting” on a transparent portion of the triangle. A typical use for the closest hit shader 310 is to color a material based on a texture for the material. A typical use for the miss shader 312 is to color a pixel with a color set by a skybox. It should be understood that the shader programs defined for the closest hit shader 310 and miss shader 312 may implement a wide variety of techniques for coloring pixels and/or performing other operations.

A typical way in which ray generation shaders 302 generate rays is with a technique referred to as backwards ray tracing. In backwards ray tracing, the ray generation shader 302 generates a ray having an origin at the point of the camera. The point at which the ray intersects a plane defined to correspond to the screen defines the pixel on the screen whose color the ray is being used to determine. If the ray hits an object, that pixel is colored based on the closest hit shader 310. If the ray does not hit an object, the pixel is colored based on the miss shader 312. Multiple rays may be cast per pixel, with the final color of the pixel being determined by some combination of the colors determined for each of the rays of the pixel. As described elsewhere herein, it is possible for individual rays to generate multiple samples, which each sample indicating whether the ray hits a triangle or does not hit a triangle. In an example, a ray is cast with four samples. Two such samples hit a triangle and two do not. The triangle color thus contributes only partially (for example, 50%) to the final color of the pixel, with the other portion of the color being determined based on the triangles hit by the other samples, or, if no triangles are hit, then by a miss shader.

It is possible for any of the any hit shader 306, closest hit shader 310, and miss shader 312, to spawn their own rays, which enter the ray tracing pipeline 300 at the ray test point. These rays can be used for any purpose. One common use is to implement environmental lighting or reflections. In an example, when a closest hit shader 310 is invoked, the closest hit shader 310 spawns rays in various directions. For each object, or a light, hit by the spawned rays, the closest hit shader 310 adds the lighting intensity and color to the pixel corresponding to the closest hit shader 310. It should be understood that although some examples of ways in which the various components of the ray tracing pipeline 300 can be used to render a scene have been described, any of a wide variety of techniques may alternatively be used.

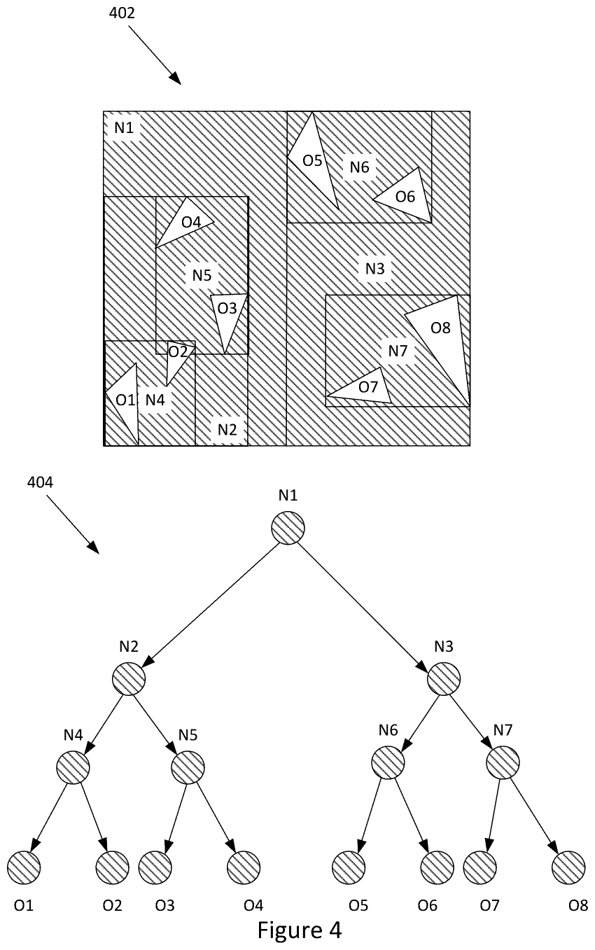

FIG. 4 is an illustration of a bounding volume hierarchy, according to an example. For simplicity, the hierarchy is shown in 2D. However, extension to 3D is simple, and it should be understood that the tests described herein would generally be performed in three dimensions.

The spatial representation 402 of the bounding volume hierarchy is illustrated in the left side of FIG. 4 and the tree representation 404 of the bounding volume hierarchy is illustrated in the right side of FIG. 4. The non-leaf nodes are represented with the letter “N” and the leaf nodes are represented with the letter “O” in both the spatial representation 402 and the tree representation 404. A ray intersection test would be performed by traversing through the tree 404, and, for each non-leaf node tested, eliminating branches below that node if the test for that non-leaf node fails. In an example, the ray intersects O₅ but no other triangle. The test would test against N₁, determining that that test succeeds. The test would test against N₂, determining that the test fails (since O₅ is not within N₁). The test would eliminate all sub-nodes of N₂ and would test against N₃, noting that that test succeeds. The test would test N₆ and N₇, noting that N₆ succeeds but N₇ fails. The test would test O₅ and O₆, noting that O₅ succeeds but O₆ fails. Instead of testing 8 triangle tests, two triangle tests (O₅ and O₆) and five box tests (N₁, N₂, N₃, N₆, and N₇) are performed.

As stated, a BVH is an important data structure for efficient ray tracing. Thus to perform ray tracing, a BVH must be built. This is a relatively heavyweight operation and thus in many instances, instead of performing a full BVH build, a refit operation is performed. While a build operation builds a BVH from scratch, a refit operation maintains the topology of a BVH while updating the bounding boxes of the BVH. The “topology” refers to the nodes and the connectivity between nodes. In other words, a refit operation updates the bounding volumes of a BVH, given updated primitive vertex information, but maintains the nodes and connectivity.

Using the example BVH of FIG. 4, a refit operation on the BVH 404 would retain the nodes—N1-N7 and O1-O8. However, the refit operation would update the bounding volumes of the non-leaf nodes N1-N7 in response to updated primitive geometry. In an example, the BVH 404 has already been constructed for a scene. Updates to geometry of the scene, including changes to vertex position for the primitives, occur. After this, a refit operation occurs. This refit operation adjusts the bounding volumes to encompass the new positions of the primitive vertices.

On a highly parallel processing device such as the APD 116, a parallel refit operation is desirable. For such an operation, care must be taken to prevent certain inefficiencies. More particularly, a refit operation is a bottom-up operation in which operations for nodes higher up in the BVH are reliant on the results of operations for nodes lower down. This dependency is the result of updated bounding volumes lower in the hierarchy being used to update bounding volumes higher in the hierarchy. On the APD 116, this dependency necessitates a communication of data from work-items processing lower nodes to work-items processing higher nodes. If nodes having such a dependent relationship are assigned to work-items executing in different compute units 132, then a more general but slower form of communication is used to communicate such data. In the example BVH of FIG. 4, if a first work-item executing on one compute unit 132 is performing a refit operation for a first node, and the result of that operation is required as input for a second work-item executing on a different compute unit 132 (e.g., because that other work-item is processing the parent node of the first node), then the first work-item writes such results to memory that is accessible to both compute units 132, such as APD memory 139, and such writes would need to use a higher level cache. If instead, both work-items were executing on the same compute unit 132, then it could be possible for these work-items to write the intermediate result into a local memory such as APD local data share 137, which is local to the compute units 132 and has better memory access characteristics (e.g., lower latency, less congested).

For this reason, techniques are provided herein to identify portions of a BVH that can be grouped together and executed in a wavefront or a workgroup. These portions—subtrees of the BVH—have the property that work for nodes lower in a subtree necessarily produce results for use by nodes higher in the subtree. By scheduling such subtrees for processing in the same workgroup, the above-mentioned dependencies remain within that workgroup, meaning that a more local memory can be used to transfer such dependencies between work-items than if the dependencies needed to be transferred between work-items executing in different compute units 132.

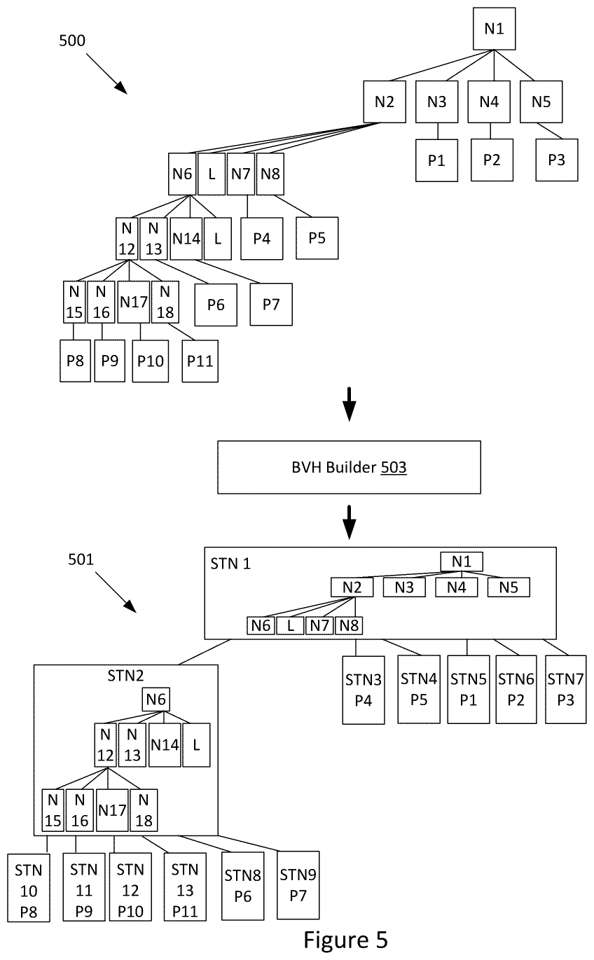

FIG. 5 illustrates operations for generating sub-trees from a BVH 500, according to an example. A BVH 500 is illustrated. The BVH includes leaf nodes (marked with an “L” for “leaf children”) and non-leaf nodes (marked with “NXX” where “XX” is a number). Non-leaf nodes have other children as nodes, as can be seen. A line from a non-leaf node down to another node indicates that the non-leaf node is the parent of the other node. In addition, some portions of the BVH 500 are marked as “PX,” where “X” is a number. These portions are portions of the BVH 500 where the additional detail is not illustrated, for the purpose of conciseness and simplicity of illustration. Such portions may include any number of nodes, including non-leaf nodes and leaf nodes, arranged into any sort of hierarchical structure permitted by the BVH 500 (e.g., limited to having a certain number of child nodes per non-leaf node).

A BVH builder 503 is present which converts the BVH 500 into a subtree BVH 501. The BVH builder 503 is embodied as software executing on a processor (such as the APD 116, the processor 102, or a combination of both), as hardware (e.g., digital circuitry configured to perform the operations described herein), or as a combination of software and hardware. The subtree BVH 501 has the property that the nodes (called “sub-tree nodes” or “STN”) of the subtree BVH 501 are, themselves, subtrees of the BVH 500. Each such subtree can be assigned to a processing element such as a workgroup, and the processing element can perform a refit operation in a manner that does not require transmission of intermediate results through global memory. In the example architecture of FIG. 2, a workgroup executes within a compute unit 132. In this example, the compute unit 132 has a local memory 137. There is also a more general memory-the APD memory 139. The local memory 137 is accessible only to the compute unit 132 that it belongs to, and the APD memory 139 is accessible to each compute unit 132. For work that is performed by a workgroup and thus limited to being within a compute unit 132, the workgroup is capable of using the local memory 137 for much of that work. In the example subtree BVH 501, if each subtree node is assigned to a single workgroup for a refit operation, then the intermediate values generated during that refit operation can be stored within the local memory 137 rather than in the APD memory 139. These intermediate values generally include adjusted bounding box coordinates for a parent that are then used to perform a refit for the parent of that parent.

Assigning a hierarchy of nodes to a single workgroup allows these adjusted bounding box coordinates to be propagated from the work-item that generated such values to the work-item(s) that then consumes those values by storing such values into the local memory 137, as it is guaranteed that the work-items are in the same compute unit 132 since they are in the same workgroup. In comparison, if it were not guaranteed that those work-items were within the same workgroup, then the work-items generating such information would need to store that information into the APD memory 139. Utilizing more local, specific memory like this is advantageous because access to local memory is often quicker than access to more global memory, and because accessing global memory more often can more easily lead to memory transaction congestion and thus reduced performance. Generating the subtree BVH 501, in which each node represents a subtree of the BVH 500, allows assignment of groups of nodes with this type of hierarchical relationship (subtrees) to workgroups, thus allowing memory transactions to be more local.

As stated above, the BVH builder 503 generates a subtree BVH 501 from the BVH 500. In an example, the BVH builder 503 performs this operation by generating a plurality of subtree nodes. Generating a subtree node (STN) is now described.

At any given point in time while being generated, a subtree node has a certain number of “bottom-most nodes.” The bottom-most nodes are nodes having no children in the subtree node. Generating a subtree node respects a maximum bottom-most node limit. More particularly, the BVH builder 503 adds bottom-most nodes to the subtree node until there are at most a number of nodes specified by this limit. If this limit is 8, then each subtree node can have at most 8 nodes.

To begin generating a subtree node, the BVH builder 503 finds a root node for the subtree node. The root node is either the root of the BVH 500 (in the very beginning), or a bottom-most non-leaf node within an already existing subtree node. The BVH builder 503 adds this root node to the subtree node under construction.

At any given time, if at least one of the bottom-most nodes of a subtree node is a non-leaf node and the number of bottom-most nodes in the subtree node is less than the maximum bottom-most node limit, then the BVH builder 503 attempts to add the children of a non-leaf node that is a bottom-most node to the subtree node. Attempting to add the children means adding the children to the subtree node, unless doing so would bring the number of bottom-most nodes above the maximum number of nodes. As can be seen, the BVH builder 503 “accumulates” a hierarchy from the BVH 500 into each subtree node. Once the subtree node has the maximum number of nodes, or once the above attempt to add children fails once, the BVH builder 503 determines that generation of that subtree node is complete.

The parent of a subtree node is the subtree node that includes, as a bottom-most node, the root of the subtree node. The children of a subtree node are the subtree nodes that are generated from the bottom-most non-leaf nodes of the subtree node. In an example, if a generated subtree node has two bottom-most non-leaf nodes, then the children of the generated subtree node would be the subtree nodes generated from the two bottom-most non-leaf nodes (e.g., setting those nodes as the root of their own new non-leaf nodes, and accumulating children until the non-leaf node limit is reached).

The example of FIG. 5 will now be described. In this example, the maximum number of bottom-most nodes is 8. In this example, the first subtree node—STN1—begins with node N1 as its root. Then the BVH builder 503 adds its children N2-N5—to STN1. As there are less than 8 nodes, the BVH builder 503 adds the children—of one of the bottom-most non-leaf nodes, which are N6, L, N7, and N8. There are now 7 bottom-most nodes. The BVH builder 503 determines that this node is complete because adding nodes from any of the bottom-most nodes would exceed the limit on the number of nodes. Next, the BVH builder generates a subtree node (STN2) for node N6. The BVH builder 503 adds N6 to SNT2, then the children of N6 (N12, N13, N14, L), bringing the number of bottom-most nodes to 4. Then, the BVH builder 503 adds the children of N12 (N15, N16, N17, N18), bringing the total to 7. At this point, adding the children of any bottom-most node would exceed the limit and so generation of STN2 terminates. There are additional subtree nodes generated, but the details of these additional nodes are not shown. For example, subtree nodes STN10, STN11, STN12, STN13, STN8, and STN9 correspond to portions of the BVH 500 P8, P9, P10, P11, P6, and P7, respectively. A similar process would be performed to generate these nodes, but the details are not illustrated. Similar, STN3, STN4, STN5, STN6, and STN7 would be generated in a similar manner.

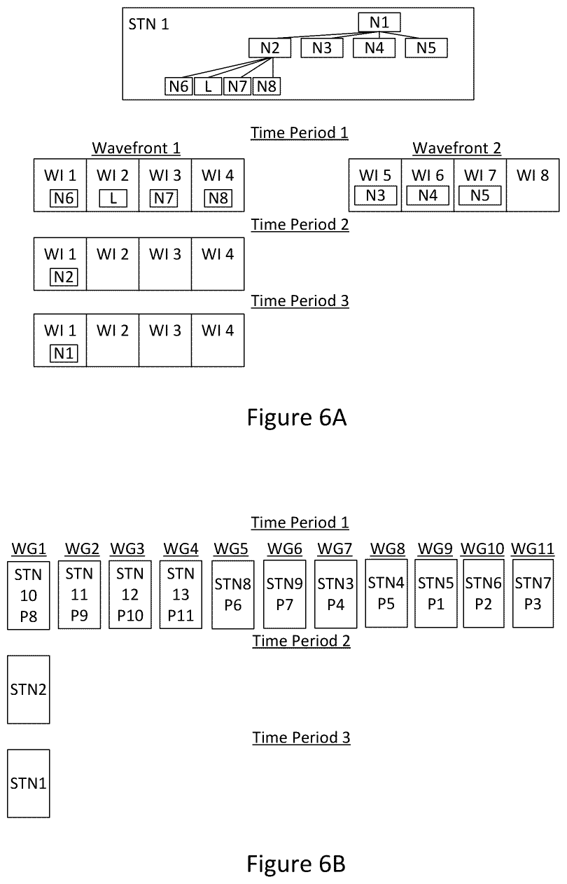

FIGS. 6A and 6B illustrate operations for performing a refit operation, using a subtree BVH 501, according to an example. FIG. 6A illustrates operations for processing a single subtree node. FIG. 6B illustrates operations for processing a full subtree BVH 501.

In FIG. 6A, a single subtree node—STN1 is being processed for a parallel refit operation. To perform this parallel refit operation, the BVH builder 503 assigns a workgroup to the subtree node STN1. This workgroup includes one or more wavefronts (two are illustrated), and each wavefront includes a plurality of work-items (illustrated as “WIx” where “x” is a number).

Performing a refit operation for a subtree node occurs in the following manner. Initially, each active work-item of the workgroup is assigned to one of the bottom-most nodes of the subtree node. Each work-item performs a refit for the node assigned to that work-item. This refit operation includes determining a bounding volume for that node. For leaf nodes, this includes determining the bounding volume that bounds the geometry (e.g., one or more triangles) of that leaf node. For non-leaf nodes, this includes determining the bounding volume that bounds the bounding volume of each child of that non-leaf node. In the example of FIG. 6A, the refit operation for node N6, includes determining a bounding volume that bounds all children of node N6. In some examples, a previous workgroup determined the bounding volume for each of the immediate children of N6 (specifically, N12, N13, N14, and the leaf node L). To perform the refit operation for N6, the assigned work-item determines the bounding volume based on that information—specifically, the bounding volume that bounds the bounding volume of each child. In some examples, such a bounding volume has, for each coordinate axis, the maximum and minimum value on that axis, out of the bounding volumes for all children.

When a work-item completes its refit operation for a node, the work-item checks if the parent of that node is within the same subtree node and whether that work-item is the last work-item to complete a refit operation for a child of that parent. If the work-item is not the last such work-item, then the work-item terminates execution. If the work-item is the last work-item, then the work-item performs the refit operation for the parent. In the example, work-item WI1 is the last work-item to perform a refit operation for a child of node N2. Therefore, work-item WI1 performs the refit operation for node N2. Similarly, the work-item performs the refit operation for node N1, since it is the last work-item to perform the refit operation for a child of node N1. In some examples, no work-item of a workgroup performs a refit operation for the root of the subtree node assigned to that workgroup, because such a refit operation is performed by the workgroup assigned to the parent of that subtree operation. One exception is the root node of the entire BVH 501, for which no workgroup is spawned.

As stated above, in the course of performing a refit operation for a subtree node, each work-item determines a bounding volume for a corresponding node. Because the wavefronts assigned to a single subtree node are within the same workgroup, the work-items are able to (and, in some examples do) write these bounding volumes into a storage that is local to the workgroup, such as the local memory 137 (rather than the APD memory 139). These bounding volumes are intermediate values used in subsequent time periods. For example, the work-items that process all children of a parent write bounding volumes for those children into local storage (e.g., local memory 137), and the work-item that performs the refit operation for the parent reads these bounding volumes from the local memory 137. Having subtree nodes allows for storage of this intermediate information locally to improve memory access. In some examples, the “final result” for a subtree node-the bounding volumes for all of the nodes-are written out to memory more global memory so that other workgroups can access that data. For example, the final result of the refit, including new bounding volumes for each node of the subtree node, are written out to more global memory such as APD memory 139. However, this still results in fewer accesses to global memory 139 than if all such values were written to global memory while the refit operation were occurring.

In summary, for any given subtree node, a workgroup is spawned to perform refit operations for the nodes of that subtree. Initially, each work-item of the workgroup is assigned to perform (and performs) a refit operation for a different bottom-most node of the subtree node. When any given work-item completes, if that work-item has a parent in the same subtree node, that work-item checks if it is the last work-item to complete the refit operation, out of all children of that parent. If that work-item is last one, then that work-item is assigned to perform the refit operation for the parent and if that work-item is not the last one, then that work-item terminates execution.

FIG. 6B illustrates a refit operation for subtree nodes of a subtree BVH 501. In this example, the BVH builder 503 spawns a workgroup for each bottom-most subtree node of the BVH. Each such workgroup performs a refit operation for its assigned subtree node. Each workgroup checks whether that workgroup is assigned to the last child of its parent to complete the refit process. The workgroup that is assigned to such a last child proceeds to perform a refit for the parent. The other workgroups terminate. In the example of FIG. 5, a workgroup is launched for each of STN10, STN11, STN12, STN13, STN8, STN9, STN3, STN4, STN5, STN6, and STN7. Workgroup 1 is the last to complete out of the children of STN2, and therefore workgroup 1 proceeds to perform the refit operation for STN2 at time period 2, while the other workgroups terminate. Similarly, workgroup 1 is assigned to the last child of STN1 to complete and thus proceeds to process STN1 at time period 3.

The examples of FIGS. 6A and 6B illustrate only one wavefront or workgroup executing after the first time period, but this will not necessarily be the typical case. For example, the first set of wavefronts or workgroups process the bottom-most nodes of a subtree node or the bottom-most subtree nodes of a subtree BVH. If there were multiple parents of these nodes (which is likely), then there would be multiple wavefronts or workgroups executing at time period time 2. If there were multiple parents of these parents, then there would remain multiple wavefronts or workgroups at time 3, and so on.

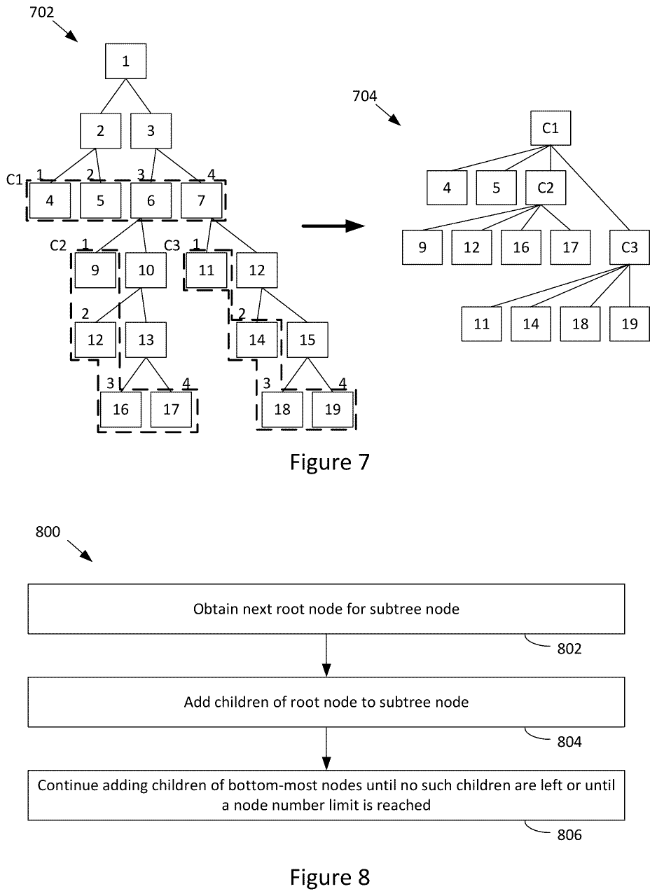

FIG. 7 illustrates a BVH widening operation, according to an example. In this example, a BVH builder 503 begins with a narrow BVH 702 and generates a wider BVH 704. To generate the wider BVH 704, the BVH builder 503 begins with a single node such as the root node, and creates a working node for that node. The BVH builder 503 adds children of that root node to the working node if such addition would not bring the number of nodes in the working node above the limit of the number of bottom-most nodes. In the example, where the limit to the number of bottom-most nodes is 4, the bottom-most nodes that are added to a particular combined node are illustrated with a dotted line. In particular, for C1, node 1 is first added to C1 as a working node, then the children of 1, which are 2 and 3. Then the children of 2 are added, resulting in bottom-most nodes of 3, 4, and 5, and then the children of 3 are added, resulting in bottom-most nodes of 4, 5, 6, and 7, which is the limit. Thus, the creation of C1 is complete. Its children are C2, C3, and nodes 4 and 5. Node C2 and C3 are created in a similar manner—node C2 has bottom-most children of 9, 12, 16, and 17, and node C3 has bottom-most children of 11, 14, 18, and 19.

It is possible for the BVH builder 503 to begin with a narrow BVH such as a BVH 2 (2 bottom-most nodes per node), and then to widen the BVH to a particular size, and then to continue this process to generate the subtree BVH. In one example, the BVH builder 503 generates a first combined node and, after reaching the limit for the combined node, continues generating the subtree node until the limit for the subtree node is reached.

In some examples, the nodes within the subtree nodes are stored as references to nodes in a widened subtree 704. In other words, while the BVH builder 503 is building a subtree BVH, and the BVH builder 503 accumulates nodes into the BVH builder 503, the BVH builder 503 stores these nodes as references to nodes in the widened subtree 704.

FIG. 8 is a flow diagram of a method 800 for building a subtree BVH, according to an example. Although described with respect to the system of FIGS. 1-6, those of skill in the art will understand that any system configured to perform the steps of the method 800 in any technically feasible order falls within the scope of the present disclosure.

At step 802, a BVH builder 503 obtains a next root node for a new subtree node to be constructed. For the highest subtree node, this next root node is the root node of the BVH. For other nodes, the next root node is a non-leaf node that is a bottom-most child of another subtree node already constructed that has not yet been used to form a subtree node. It should be understood that the BVH builder 503 is adding nodes from a BVH that is at least partially built (e.g., based on a widening procedure) or fully built. The nodes that are added in any of the steps 802-806 are references to nodes of this partially or fully built BVH.

At step 804, the BVH builder 503 adds the children of that root node to the subtree node. This step simply involves the BVH builder 503 adding references to these children in the at least partially built BVH, in to the new subtree node being built. At step 806, the BVH builder 503 continues to add children of bottom-most non-leaf nodes of the subtree node until doing so would exceed the numerical limit for the number of bottom-most nodes of the subtree BVH. At this point, the subtree node is constructed. After this, in various examples, the BVH builder 503 builds additional subtree nodes, for each bottom-most non-leaf node, repeating this process until all bottom-most subtree nodes of the BVH contain only leaf nodes (and not non-leaf nodes).

It should be understood that the BVH subtree is a helper structure used to accelerate parallelization of the construction process for the subtree BVH.

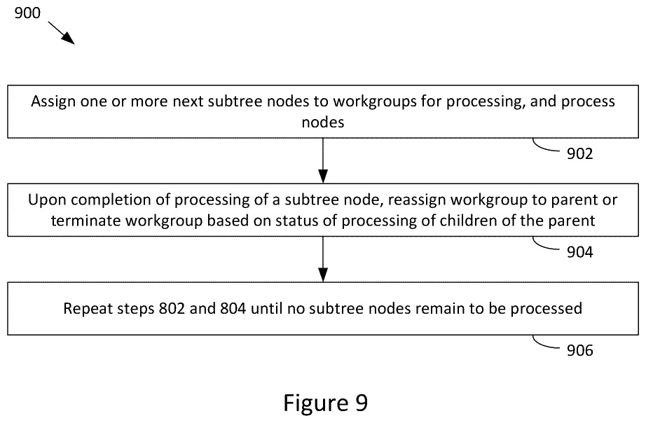

FIG. 9 is a flow diagram of a method 900 for performing a refit operation, according to an example. Although described with respect to the system of FIGS. 1-6, those of skill in the art will understand that any system configured to perform the steps of the method 900 in any technically feasible order falls within the scope of the present disclosure.

At step 902, a BVH builder 503 assigns one or more subtree nodes to workgroups for processing, and the workgroups process those nodes. In various examples, the refit operation for a subtree node is performed as described with respect to FIG. 6A. In general, a single workgroup determines new bounding volumes for the nodes of the subtree node in a bottom-up manner, with the last work-item processing a child for a parent advancing to perform the refit for the parent. The intermediate values the new bounding volumes determined and used for refits for parents-are stored in a local memory such as memory 137, rather than in a more global memory such as APD memory 139, except that the final results are written to the global memory 139 at the end of the refit operation for a single subtree node.

At step 904, upon completion of processing of a subtree node, the BVH builder 503 either reassigns the workgroup that completed to a parent or terminates that workgroup. Whether to reassign is based on whether the workgroup is the last workgroup to complete a child for a parent node. In other words, if there are no more child nodes of a parent to process for a refit operation, then the workgroup is reassigned and if there are other child nodes whose refit operation has not completed, then the workgroup is terminated.

At step 906, the BVH builder 503 repeats steps 902 and 904 until there are no more subtree nodes that remain to be processed. A workgroup that begins processing a new subtree reads the data for its bottom-most nodes from the global memory such as APD memory 139.

After the refit operation is performed, the newly adjusted BVH (e.g., the widened BVH of FIG. 6) is used to perform ray tracing operations. In various examples, the ray tracing pipeline 300 processes rays to determine pixel colors for pixels using this newly adjusted BVH. In various examples, the ray tracing pipeline 300 casts rays into the scene, where each ray passes through a virtual pixel of a virtual image and into the scene geometry. The ray tracing pipeline 300 determines colors for each such ray by determining what is intersected by the ray (e.g., using a BVH traversal technique that traverses a BVH modified by the refit operation) and coloring the pixel based on the object intersected by the ray (e.g., applying texture, lighting, colors, or other aspects, based on the object intersected by the ray and where on the object the ray intersects).

Note that although the same element—a BVH builder 503—is described as performing both the build of the subtree BVH (FIG. 8) and the refit operation (FIG. 9), it is possible for two different BVH builders 503 to perform the different methods. Thus, for example, it is not necessary for a BVH builder 503 that builds a subtree BVH to also perform a refit operation and it is not necessary for a BVH builder 503 that performs a refit operation to also build a subtree BVH.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, auxiliary devices 106, the accelerated processing device 116, the input/output devices 117, the scheduler 136, the compute units 132, the parallel processing units 138, the ray tracing pipeline 300, including the ray generation shader 302, acceleration structure traversal stage 304, any hit shader 306, hit or miss unit 308, closest hit shader 310, the miss shader 312, or the BVH builder 503, may be implemented as a general purpose computer, a processor, a processor core, or in digital circuitry or analog circuitry, or as a program, software, or firmware, stored in a non-transitory computer readable medium or in another medium, executable by a general purpose computer, a processor, or a processor core. Anything described as “circuitry” could be implemented as programmable hardware, or as a program, software, or firmware, stored in a non-transitory computer readable medium or in another medium, executable by a general purpose computer, a processor, or a processor core. The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method comprising:
assigning a first subtree of a bounding volume hierarchy (“BVH”) to a first workgroup;
performing a refit operation for a first BVH using the first subtree by the first workgroup;
upon completion of the refit operation, reassigning or terminating the first workgroup; and
rendering a scene using the first BVH.

2. The method of claim 1, wherein the refit operation comprises storing intermediate results into a memory local to a compute unit associated with the first workgroup.

3. The method of claim 1, wherein:
the first workgroup is the last workgroup to perform a refit operation out of all children of a parent of the first subtree; and
reassigning or terminating the first workgroup comprises reassigning the first workgroup to perform a refit operation for the parent.

4. The method of claim 1, wherein:
the first workgroup is not the last workgroup to perform a refit operation out of all children of a parent of the first subtree; and
reassigning or terminating the first workgroup comprises terminating the first workgroup.

5. The method of claim 1, further comprising repeating the steps of assigning, performing, and reassigning or terminating until no more subtrees remain to be processed.

6. The method of claim 1, wherein the refit operation comprises updating bounding volumes of the first BVH.

7. The method of claim 1, further comprising performing a refit operation for additional subtrees in parallel with the refit operation using the first subtree by the first workgroup.

8. The method of claim 1, further comprising building the BVH.

9. The method of claim 8, wherein building the subtree BVH is performed in conjunction with a BVH widening operation.

10. A system comprising:
a memory configured to store at least a portion of a first bounding volume hierarchy (“BVH”); and
a processor configured to:
assign a first subtree of a BVH to a first workgroup;
perform a refit operation for the first BVH using the first subtree by the first workgroup;
upon completion of the refit operation, reassign or terminate the first workgroup; and
render a scene using the first BVH.

11. The system of claim 10, wherein the refit operation comprises storing intermediate results into a memory local to a compute unit associated with the first workgroup.

12. The system of claim 10, wherein:
the first workgroup is the last workgroup to perform a refit operation out of all children of a parent of the first subtree; and
reassigning or terminating the first workgroup comprises reassigning the first workgroup to perform a refit operation for the parent.

13. The system of claim 10, wherein:
the first workgroup is not the last workgroup to perform a refit operation out of all children of a parent of the first subtree; and
reassigning or terminating the first workgroup comprises terminating the first workgroup.

14. The system of claim 10, wherein the processor is further configured to repeat the steps of assigning, performing, and reassigning or terminating until no more subtrees remain to be processed.

15. The system of claim 10, wherein the refit operation comprises updating bounding volumes of the first BVH.

16. The system of claim 10, wherein the processor is further configured to perform a refit operation for additional subtree nodes in parallel with the refit operation using the first subtree by the first workgroup.

17. The system of claim 10, wherein the processor is further configured to build the BVH.

18. The system of claim 17, wherein building the subtree BVH is performed in conjunction with a BVH widening operation.

19. A non-transitory computer-readable medium storing instructions that, when executed by a processor, cause the processor to perform operations comprising:
assigning a first subtree of a bounding volume hierarchy (“BVH”) to a first workgroup;
performing a refit operation for a first BVH using the first subtree by the first workgroup;
upon completion of the refit operation, reassigning or terminating the first workgroup; and
rendering a scene using the first BVH.

20. The non-transitory computer-readable medium of claim 19, wherein the refit operation comprises storing intermediate results into a memory local to a compute unit associated with the first workgroup.
